(19) United States
(12) Patent Application Publication
(10) Pub. No.: US 2024/0247685 A1
(43) Pub. Date: Jul. 25, 2024

(54) GEAR AND USE OF A GEAR

(71) Applicant: WITTENSTEIN SE, Igersheim (DE)

(72) Inventors: Heiko Schreiber, Doberschau (DE); Markus Schlauch, León (ES)

(73) Assignee: WITTENSTEIN SE, Igersheim (DE)

(21) Appl. No.: 18/418,824

(22) Filed: Jan. 22, 2024

(30) Foreign Application Priority Data
Jan. 23, 2023 (DE) 102023101575.3

(51) Int. Cl. F16C 19/38; F16H 25/06

(52) U.S. Cl. CPC F16C 19/381; F16H 25/06; F16C 2361/61

(57) ABSTRACT

A gear mechanism (1), in particular coaxial gear mechanism, having a housing with a fixedly arranged toothing (3), a tooth carrier (5) rotatable about a gear mechanism axis relative to the housing and guides (7), teeth (9), which are received in the guides (7) for engagement with the toothing (3), wherein the teeth (9) are mounted in the guides (7) so as to be displaceable in the direction of their longitudinal axis relative to the tooth carrier (5), a cam disk (13) rotatable about the gear mechanism axis (11) and intended to drive the teeth (9) along the respective longitudinal axis of the teeth (9), and a bearing row (35, 37) between the tooth carrier (5) and the housing for mounting the tooth carrier in the housing, wherein the bearing row (35, 37) includes axial rolling bodies, the axes of rotation of which are aligned perpendicularly in relation to the gear mechanism axis (11), and radial rolling bodies, the axes of rotation of which are aligned parallel to the gear mechanism axis (11).

### FIELD OF THE INVENTION

The invention relates to a gear mechanism and to the use of a gear mechanism.

### PRIOR ART

The prior art discloses gear mechanisms comprising teeth which are mounted so as to be radially displaceable in a tooth carrier. To drive the teeth, use is made of drive input elements with a profiling, such as cam disks. The teeth engage in a toothing such that a relative movement occurs between the tooth carrier with the teeth and the toothing. In this respect, the relative movement between the toothing and the teeth is smaller than the movement of the drive input element with the profiling by at least one order of magnitude. In this way, high transmission ratios can be achieved; an example of such a gear mechanism is disclosed in DE 10 2015 119 582 A1.

However, under certain circumstances known gear mechanisms do not meet the requirements for compactness of the gear mechanism in the case of restricted structural space requirements. Furthermore, it can be desirable to improve radial or axial run-out for some applications.

### SUMMARY OF THE INVENTION

An object of the invention is to specify a gear mechanism which is improved over gear mechanisms known from the prior art, wherein in particular the intention is to provide a more compact gear mechanism with as large as possible a hollow-shaft diameter and improved radial or axial run-out properties. Another object of the invention is to specify a use of such a gear mechanism.

The object is achieved by a gear mechanism as disclosed herein and by the use as disclosed herein. Advantageous refinements and embodiments will emerge from the dependent claims and from this description.

One aspect of the invention relates to a gear mechanism, in particular coaxial gear mechanism, comprising a housing with a fixedly arranged toothing, a tooth carrier which is rotatable about a gear mechanism axis relative to the housing and has guides, teeth, which are received in the guides for engagement with the toothing, wherein the teeth are mounted in the guides so as to be displaceable in the direction of their longitudinal axis relative to the tooth carrier, a cam disk which is rotatable about the gear mechanism axis and is intended to drive the teeth along the respective longitudinal axis of the teeth, and a bearing row between the tooth carrier and the housing for mounting the tooth carrier in the housing, wherein the bearing row comprises axial rolling bodies, the axes of rotation of which are aligned perpendicularly in relation to the gear mechanism axis, and radial rolling bodies, the axes of rotation of which are aligned parallel to the gear mechanism axis. In this respect, the axial rolling bodies are designed to react bearing forces acting in the axial direction of the gear mechanism longitudinal axis and the radial rolling bodies are designed to react radially acting bearing forces.

In the case of typical gear mechanisms, the teeth are mounted in the guides of the tooth carrier so as to be displaceable in the radial direction with respect to an axis of rotation of the gear mechanism. The respective longitudinal axes of the teeth are typically aligned radially with respect to the axis of rotation of the gear mechanism or of the tooth carrier. In typical embodiments, the guides of the tooth carrier are aligned radially with respect to the axis of rotation of the cam disk. Typically, the teeth are mounted linearly radially relative to the tooth carrier. In this context, “linearly radially” usually means that a guide in the radial direction is present which allows only a movement of the tooth in the radial direction and in particular a tilting of the tooth within the scope of the guidance play.

The axial rolling bodies and the radial rolling bodies form a bearing also referred to as axial-radial bearing.

Another aspect of the invention relates to the use of a gear mechanism in one of the typical embodiments described herein.

Embodiments in particular relate to coaxial gear mechanisms. Usually, typical gear mechanisms comprise a cam disk with a profiling as drive input element and a ring gear with an internal toothing or an external drive input element with inner profiling and an internal gearwheel, which for the case of the external drive input element provides the toothing. The toothing is typically a ring gear toothing around the circumference. The teeth or the tooth tips of the teeth engage in the toothing, wherein the teeth are typically mounted so as to be radially displaceable relative to the tooth carrier.

Typical embodiments can also be used in the opposite transmission direction; in this case, the cam disk is used as drive output element and the tooth carrier as drive input element. In this way, for example, a generator can be driven via the cam disk, wherein a torque that drives the tooth carrier with a low rotational speed is utilized. Drive input or output via the housing, or the toothing of the ring gear, is also possible.

In other typical embodiments, the guides of the tooth carrier are aligned parallel with respect to the axis of rotation of the cam disk. Typically, the teeth are mounted in the guides of the tooth carrier so as to be axially displaceable with respect to the axis of rotation of the cam disk. Typically, the teeth are mounted linearly axially relative to the tooth carrier. “Linearly axially” usually means that a guide in the axial direction is present, which allows only a movement of the tooth in the axial direction. The teeth or the tooth tips of the teeth engage in a toothing around the circumference. The toothing is typically in the form of a crown gear toothing.

Typical gear mechanisms of embodiments comprise exactly one row of guides or teeth in exactly one tooth carrier. This enables a particularly compact structure. In other embodiments, gear transmissions have two rows of guides or teeth in a tooth carrier.

Typically, the teeth are mounted in the tooth carrier so as to be displaceable in each case in exactly one direction, typically in the direction of the longitudinal axis of the tooth. This can be achieved, for example, in that the tooth over a certain length, in particular over a certain length along the longitudinal axis of the tooth, has a constant cross section in the displacement direction, wherein the guide for the tooth in the tooth carrier is in the form of a slot or opening with a constant cross section.

In typical embodiments of the gear mechanism according to the invention, at least some of the teeth have a flexurally rigid design. The expression “flexurally rigid” in this case is typically to be understood in the technical sense, that is to say that bending of the teeth, owing to the rigidity of the material of the teeth, is so slight as to be at least substantially insignificant for the kinematics of the gear mechanism. Flexurally rigid teeth include in particular teeth which are made from a metal alloy, in particular steel or a titanium alloy, a nickel alloy or other alloys. Furthermore, flexurally rigid teeth of plastic can also be provided, in particular in the case of gear mechanisms in which at least one of the following parts is likewise also made from plastic: toothing on a ring gear or a gearwheel, tooth carrier and drive input element. In typical embodiments of the invention, the tooth carrier and the teeth are made from a metal alloy or additionally also the toothing or further additionally the drive input element is made from a metal alloy. Such gear mechanisms offer the advantage of being extremely resistant to torsion and able to bear high loads. Gear mechanisms of plastic offer the advantage of having a low weight. The term “flexurally rigid” in particular means flexural rigidity about a transverse axis of the tooth. This means in particular that, considering the tooth as a beam from a tooth root to a tooth flank region, there is flexural rigidity which at least substantially excludes bending deformations between the tooth flank region and the tooth root. As a result of the flexural rigidity, an ability to bear extremely high loads and a resistance to torsion of the gear mechanism is achieved.

In typical embodiments, a pivot segment, which is mounted on a roller bearing that in turn rests on the profiling, is arranged between the tooth and the profiling. Typically, the tooth is loosely connected to the pivot segment. In this respect, “loose connection” preferably means that the tooth segment is only positioned, usually directly positioned, on the pivot segment. Preferred pivot segments comprise a profile which prevents the tooth slipping off of the pivot segment or the pivot segment slipping at least in one direction. Such a profile can for example be a bead, which engages in a recess in the tooth root of the tooth. For a possible embodiment of a pivot segment, reference is made to DE 10 2015 105 523 A1.

The toothing and the teeth typically have curved flanks. Examples of curvatures of the flanks are a cylindrical curvature, a curvature of the flanks along a helix or a helical surface about the axis of rotation of the coaxial gear mechanism, or a curvature in the form of a logarithmic spiral. For a possible embodiment of a curvature in the form of a logarithmic spiral, reference is made to DE 10 2007 011 175 A1. The curved surface offers the advantage that the engaging flanks are abutting over their entire surface area and not just in a line or at certain points. In this way, extreme rigidity in the event of force transmission between the toothing and the teeth is achieved. “Flanks” are understood herein in particular to mean tooth flanks of the teeth or flanks of the toothing.

In typical embodiments, the housing has a multi-part form and comprises a first housing part in the form of a bearing outer ring, wherein a ring gear with the inner toothing forms a second housing part of the housing. Moreover, some typical embodiments have a third housing part, in the form of a bearing flange, for mounting the cam disk.

In typical embodiments, the tooth carrier has a one-part form. As a result of the drive output mounting of typical gear mechanisms, which is located on one side of the transmission kinematics, the structure of the tooth carrier is considerably simplified and an overall highly compact design is possible. The tooth carrier has a relatively homogeneous diameter.

In typical embodiments, the tooth carrier comprises at least one radial bearing running surface and at least one axial bearing running surface. The radial bearing running surface and the axial bearing running surface or at least one or the two are typically designed integrally with or in the tooth carrier. Typically, axial rolling bodies or radial rolling bodies run directly on the tooth carrier or on the radial bearing running surface or on the axial bearing running surface, respectively.

In typical embodiments, the bearing row is a first bearing row of a bearing of the tooth carrier, wherein the bearing comprises a second bearing row which has at least axial rolling bodies. Typically, the tooth carrier has two radial and two axial bearing running surfaces. Each bearing row typically has a total of two axial and two radial bearing running surfaces, wherein one axial bearing running surface and one radial bearing running surface are typically formed by the tooth carrier.

The mounting of the tooth carrier typically consists of two bearing rows separated by a web located on the tooth carrier, and cylindrical rollers in the form of rolling bodies with a smaller cross section, that is to say the rolling body has a larger diameter than it does length, are inserted in the web. In this case, the special roller shape makes it possible to accommodate at the same time axially and radially arranged rolling bodies in a bearing row. Therefore, the pressure angles by contrast to cross roller bearings are not +−45°, but 0° and 90°, as a result of which typically a pure axial-radial bearing is formed. Bringing the differently aligned rolling bodies together in a respective bearing row enables a compact structure with high precision.

Typical bearing rows have four bearing running surfaces in each case: radially inner, radially outer, axially left-hand and axially right-hand. The tooth carrier typically has two respective radial and axial bearing running surfaces in the form of integrated constituent parts or can in some embodiments also be referred to as bearing inner ring. The bearing outer ring may be part of the housing and typically comprises two radial and one axial bearing running surfaces, in particular one first outer axial bearing running surface, and a receptacle for an axial bearing ring. In another embodiment, the bearing outer ring may be received in a gear mechanism housing.

Typical gear mechanisms comprise an axial bearing ring, which has an axial bearing running surface. The axial bearing ring can be used to preload the axial bearing rows. The axial bearing ring typically forms or comprises the last or second outer axial bearing running surface. An axial preload of the bearing rows can be set over the width of the axial bearing ring in coordination with an adjacent ring gear. This makes it possible to precisely set the preload in defined fashion, wherein shaft nuts can be dispensed with in some embodiments. In the mounted state, the axial bearing ring provides centering for an adjacent ring gear by virtue of a preferably present axial projection. A highly compact gear mechanism configuration is enabled. The flexibility of the axial bearing ring can jointly ensure, by coordination of fits, that as far as possible no or few radial deformations are introduced into the ring gear or the bearing outer ring. A further advantage can be that two planar surfaces on the ring gear can be produced easily with high grades of flatness and parallelism, since laterally protruding centering means are not imperatively necessary.

Typically, the two bearing rows are arranged next to one another or next to the guides in the tooth carrier on one side in the direction of the gear mechanism axis. One advantage of such an arrangement can be easy mounting.

In typical embodiments, the radial rolling bodies or the axial rolling bodies respectively of the first bearing row or the second bearing row each have a cylindrical shape with a diameter which is larger than a length of the cylindrical shape. Typically, the bearing rows are in the form of cylindrical roller bearings, wherein the rolling bodies in particular have a squat cylindrical shape. In this way, the rolling bodies roll on their running surfaces. In typical embodiments, the axial and radial rolling bodies have substantially identical forms, in particular the rolling bodies of one bearing row have identical forms.

Typically, the first bearing row and the second bearing row each have axial rolling bodies and radial rolling bodies. In this way, two axial-radial bearing rows are provided. By varying the fitting of the two bearing rows with radial or axial rolling bodies, the properties of the mounting in terms of load-bearing capacity and rigidity in the radial and axial direction, respectively, can be varied, which enables individual adaptation to usage applications. Typically, the following boundary condition must be satisfied: at least one bearing row must have a minimum number of radial rolling bodies, in order to ensure a radial guide. The two bearing rows must have a minimum number of axial rolling bodies, in order to enable an axial preload. In typical embodiments, at least one bearing row has 30% radial rolling bodies and the two bearing rows have at least 30% axial rolling bodies. In typical embodiments, the second bearing row comprises exclusively axial rolling bodies.

Typical gear mechanisms have spacing means inserted between the rolling bodies. The spacing means are typically each arranged between two adjacent rolling bodies of one bearing row. The spacing means can also be referred to as “spacers”. With spacing means, a final pitch-circle play can be set easily and cleanly. Direct contact between the rolling bodies can be reliably prevented. Favorable tribological behavior in the contacts can be provided. In particular in the case of applications with very low rotational speeds, it is also possible, if appropriate, to dispense with spacing means. Such embodiments without spacing means with full-roller occupation typically have more rolling bodies in comparison with embodiments with spacers, in order to increase load rating and rigidity. Completely dispensing with spacing means can be expedient in particular in the case of a symmetrical occupation.

By selecting the number and arrangement of rolling bodies, individual adaptation to applications is possible, wherein axial rolling bodies can increase the tilting stability and axial rigidity. Radial rolling bodies can increase the radial rigidity. What is referred to as a full-roller structure, which in particular makes do without spacing means, enables more rolling bodies and thereby increased rigidity and load-bearing capacity, in particular at low rotational speeds.

Possible scenarios for different occupations are in particular: a uniformly alternating occupation with respectively the same number of radial and axial rolling bodies, which are separated by spacing means, can in particular be expedient in the event of an unforeseeable or difficult-to-foresee load constellation. An identical occupation of the two bearing rows is also referred to as symmetrical occupation.

If very great radial forces dominate, as for example in the case of a counter-mounted pivot bridge, embodiments with more radial rolling bodies than axial rolling bodies can offer advantages. Thus, for example, occupation of the rows with respectively one third axial and two thirds radial rolling bodies would be possible. In the case of this structure, spacing means between the radial rolling bodies are not necessarily imperative.

In the case of applications with relatively low masses but a long lever arm or forces acting transversely to the gear mechanism axis, in some embodiments it is possible to offset the resulting tilting moment by an occupation with more axial rolling bodies than radial rolling bodies. For example, with an occupation of the bearing rows with respectively two thirds axial and one third radial rolling bodies.

In embodiments which must react great compressive or tensile forces in the axial direction, for example those which are installed with the drive output at the top in a turntable, wherein very large masses rest on the turntable, a bearing row can be occupied purely with axial rolling bodies, in order to offset the compressive forces. The second bearing row can be occupied in equal parts alternately with axial rolling bodies and radial rolling bodies.

In the case of gear mechanisms which are exposed to great compressive or tensile forces and at the same time prevailing tilting moments, typical embodiments with a first bearing row with purely axial occupation and a second bearing row with two thirds axial and one third radial occupation can offer advantages.

Typically, the two bearing rows can have evenly alternately axially and radially arranged rolling bodies, wherein one of the two bearing rows has uniformly or non-uniformly alternately arranged rolling bodies. A non-uniform arrangement is for example an arrangement in which two rolling bodies of the one type, that is to say either axial or radial, and then one rolling body of the other type, that is to say radial or axial, respectively, are installed in a row one behind another in the circumferential direction.

Typically, the bearing outer ring has at least one axial and at least one, typically exactly two, radial bearing running surfaces. Typically, the radial rolling bodies and the axial rolling body run directly on the bearing outer ring. In typical embodiments, the cam disk is in the form of a hollow shaft. Typically, the hollow shaft in the form of a drive input shaft or drive output shaft has a plurality of portions on the outer circumference in the axial direction. The hollow shaft and the cam disk can be designed integrally. One of the portions typically forms the elevations on the cam disk. Further portions can, for example, comprise one or more bearing portions for receiving at least one bearing. In some embodiments, the hollow shaft can have a multi-part form, for example with hollow-shaft parts arranged one behind another in the axial direction. This can offer the advantage of being able to form a module with different combinations of bearing portions and cam disks. This can offer high flexibility and cost advantages. Simplified production can be enabled, since the various portions can be processed more easily and selectively according to their different requirements, for example in terms of material, surface finish, heat treatment or the like.

The radial compactness of the drive output mounting permits a considerably larger hollow shaft in comparison with the previous design. This can be used in applications for a media feed-through or for accommodating a pre-stage in the case of a multi-stage structure, in order to realize a two-stage structure with a short axial structural length. In the case of typical gear mechanisms, the hollow shaft has an inside diameter which is at least 30%, preferably at least 36% of the outside diameter of the gear mechanism. The mounting of typical embodiments can enable such a large inside diameter. The pilot stage may in this case be in the form of a planetary pre-stage, wherein the cam disk forms the planetary carrier and a ring gear toothing of the planetary stage is connected to the tooth carrier.

Advantageous in manufacturing terms is the subdivision of the housing into a drive output mounting part with the bearing outer ring and a part with the toothing of the ring gear. The two parts are subject to very different loading and can thus be optimally adapted to their task in each case in terms of material, but also the heat treatment.

Advantageous for the mounting is the defined setting of the bearing preload as a result of selectable components. Adjustment by means of shaft nuts can be dispensed with, and therefore fluctuating bearing preloads can largely be avoided.

Further advantages of embodiments can be: a drive input mounting which is highly compact in all dimensions and enables a considerable increase in the hollow-shaft diameter and a decrease in the structural length of the gear mechanism. Easier and less expensive production of the bearing running surfaces, as perpendicular or parallel to the gear mechanism axis. More straightforward geometry of the tooth carrier and the housing parts, with the result that less expensive production and more individual processing are possible. Precise mounting on account of low tolerances of the individual parts and high load-bearing capacity. Improved radial and axial run-out on account of the integrated bearing running surfaces. Easier setting of the bearing preload through axial bearing ring and selected components. A shaft nut is not imperatively necessary. Individual adaptation of the occupation with rolling bodies to the use case is possible.

Typical gear mechanisms according to the invention are used, for example, in robotics, in machine tools, packaging machines, turning or milling machines and other industrial drivetrains. In generator mode, they can be used in wind power plants or other energy generation plants.

They are particularly advantageous for applications with high requirements in terms of torque and power density, large hollow-shaft diameter, high rigidity, low play or zero play or compactness.

### BRIEF DESCRIPTION OF THE DRAWINGS

The invention will be explained in more detail below on the basis of the appended drawings, wherein, in the figures:

FIG. 1 shows a schematic cross section through a typical embodiment;

FIG. 2 shows part of the typical embodiment of FIG. 1 in a perspective, schematic view;

FIG. 3 shows part of a typical embodiment in a perspective, schematic view;

FIG. 4 shows part of a typical embodiment in a perspective, schematic view;

FIG. 5 shows part of a typical embodiment in a perspective, schematic view; and

FIG. 6 shows only rolling bodies of a typical embodiment in a perspective, schematic view.

### DETAILED DESCRIPTION

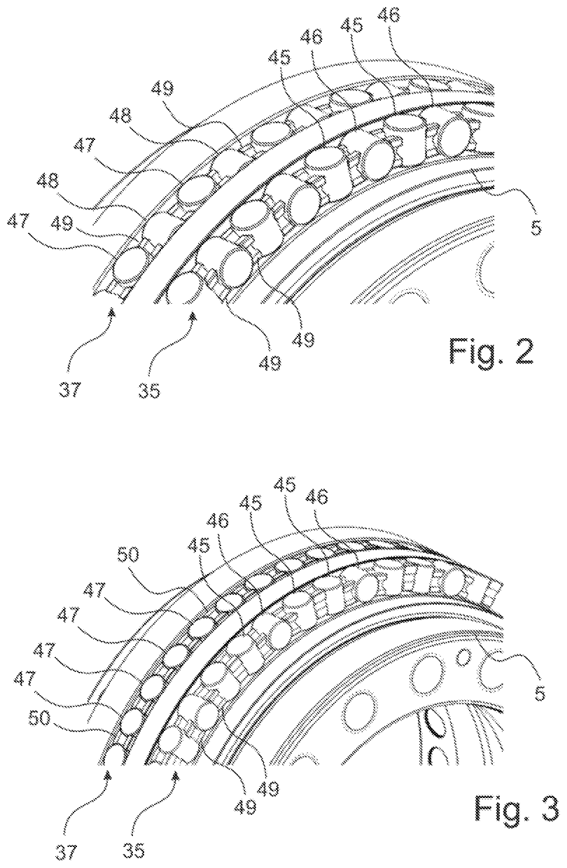

Typical embodiments of the invention will be described below on the basis of the figures, wherein the invention is not restricted to the exemplary embodiments; instead the scope of the invention is determined by the claims. In the description of the embodiments, under certain circumstances in various figures and for various embodiments the same reference signs are used for parts that are the same or similar. In part, features which have already been described in connection with other figures are not described again for the sake of clarity. For the sake of clarity, in part not all of the relevant features are provided with a reference sign, for example in FIG. 2 the rolling bodies and the spacing means.

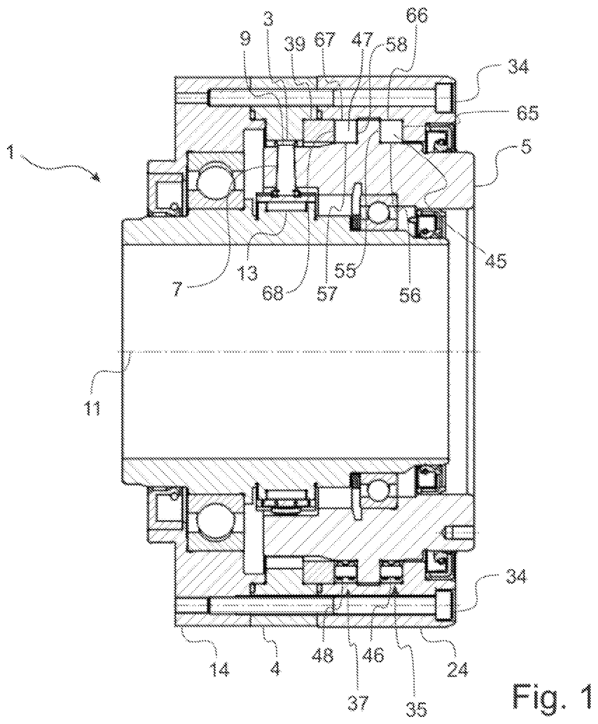

FIG. 1 is a schematic cross section through a typical embodiment of the invention. FIG. 1 shows a gear mechanism 1 comprising teeth 9, which are received so as to be displaceable in guides 7 of a tooth carrier 5. The tooth carrier 5 is mounted so as to be able to rotate about a gear mechanism axis 11 of the gear mechanism 1.

The tooth carrier 5 is arranged between a toothing 3 of a ring gear 4 and a cam disk 13 and also forms the drive output. The ring gear 4 and the cam disk 13 are likewise arranged concentrically in relation to the gear mechanism axis 11. The drive output is on the right-hand side in FIG. 1. The tooth carrier 5 is formed in one piece with the drive output. Like all embodiments, the gear mechanism 1 can also be operated in the opposite direction, wherein the tooth carrier 5 forms the input-side drive of the gear mechanism 1.

In FIG. 1, the guides 7 are aligned radially and the teeth 9 are mounted in the guides 7 so as to be linearly radially displaceable. In particular, the teeth 9 are displaceable along their respective longitudinal axis. The longitudinal axis is aligned parallel to the respective guide 7. The teeth 9 may be radially displaced for engagement with a toothing 3 of the ring gear 4. In FIG. 1, in each case only one tooth 9 and one guide 7 are shown in section in the sectional view. For further information relating to the structure, reference is made to DE 10 2015 119 582 A1.

In the gear mechanism 1 of FIG. 1, the cam disk 13 usually serves as drive input element of the gear mechanism 1. The cam disk 13 has a profiling in the circumferential direction of the cam disk 13. The profiling has a course with two elevations over the circumference, which apply load to the teeth 9 in the radial direction.

In the embodiment of FIG. 1, the cam disk 13 is formed integrally with a hollow shaft. The inside diameter of the hollow shaft is more than 30% the outer circumference of the gear mechanism 1.

The gear mechanism 1 has a multi-part housing, wherein the ring gear 4 forms a second housing part of the housing. The ring gear 4 is clamped between a first housing part 24 in the form of a bearing outer ring and a third housing part 14 of the housing, wherein screws 34 press the housing parts 14 and 24 in each case against the centrally arranged ring gear 4.

The tooth carrier 5 is mounted in the part 24 of the housing of the gear mechanism 1 by means of a first bearing row 35 and a second bearing row 37. The bearing rows 35 and 37 each comprise axial rolling bodies 45 and 47, respectively, the axes of rotation of which are aligned perpendicularly in relation to the gear mechanism axis 11, and radial rolling bodies 46 and 48, respectively, the axes of rotation of which are aligned parallel to the gear mechanism axis 11. The rolling bodies 45-48 are illustrated in FIG. 2, which shows a detail of the embodiment of FIG. 1 in a schematic perspective partial view.

In FIG. 1, two axial rolling bodies 45 and 47 are illustrated in the top half of the drawing. The rolling bodies 45-48 each have a diameter which is larger than the length of the rolling body. In this way, the rolling bodies 45-48 roll on running surfaces without the end faces of the cylindrical rolling bodies 45-48 coming into load-bearing contact with the running surfaces.

The radial rolling bodies 46 and 48 run on inner radial bearing running surfaces 56 and 57 of the tooth carrier 5 and on outer radial bearing running surfaces 66 and 67 of the part 24 of the housing of the gear mechanism 1. The axial rolling bodies 45 and 47 run on inner axial bearing running surfaces 55 and 58 of the tooth carrier 5, which are formed by a web of the tooth carrier. Furthermore, the rolling bodies 45 of the first bearing row 35 run on a first outer axial bearing running surface 65 of the part 24 of the housing of the gear mechanism 1. An axial bearing ring 39 forms a second outer axial bearing running surface 68 for the axial rolling body 47, as shown in FIG. 1 in the bottom half of the image.

The axial bearing ring 39 is supported in the axial direction on the ring gear 4 and the first housing part 24 and can be selected in terms of its axial dimension in order to generate a defined axial preload in the bearing rows 35 and 37.

In FIG. 2, some details of the embodiment of FIG. 1 are schematically shown in a perspective partial illustration. The ring gear and housing are removed.

The first bearing row 35 and the second bearing row 37 each alternately have, in a ratio 1:1, axial rolling bodies 45 and 47, respectively, and radial rolling bodies 46 and 48, respectively. Respective spacing means 49 are arranged between the rolling bodies.

FIGS. 3-5 each show a part of further typical embodiments in perspective, schematic views. The embodiments of FIGS. 3-5 in many elements correspond to the embodiment of FIGS. 1 and 2, and therefore a description of identical elements is omitted.

FIG. 3 shows a detail of bearing rows 35 and 37 of a typical embodiment in a perspective, schematic view. The first bearing row 35 has first axial rolling bodies 45 and first radial rolling bodies 46 alternately in the ratio 2:1. The second bearing row 37 has exclusively second axial rolling bodies 47 and no radial rolling bodies. Respective spacing means are arranged between the rolling bodies of the two bearing rows 35 and 37. In this respect, a spacing means 50 with concave recesses arranged symmetrically in relation to one another is provided between two identically aligned rolling bodies of the bearing row 37. By contrast, the spacing means 49, arranged between a radial and an axial rolling body, in the bearing row 35 has two concave recesses arranged rotated by 90° in relation to one another.

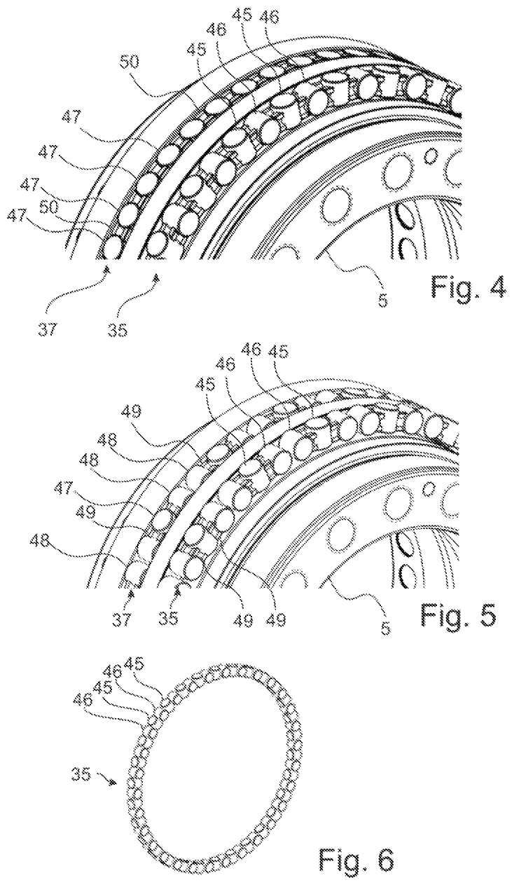

FIG. 4 shows a detail of bearing rows 35 and 37 of a typical embodiment in a perspective, schematic view. The first bearing row 35 has first axial rolling bodies 45 and first radial rolling bodies 46 alternately in the ratio 1:1. The second bearing row 37 has exclusively second axial rolling bodies 47 and no radial rolling bodies. Spacing means 50 are arranged between the axial rolling bodies of the bearing row 35 and spacing means 49 are arranged between the axial and radial rolling bodies in the bearing row 37.

FIG. 5 shows a detail of bearing rows 35 and 37 of a typical embodiment in a perspective, schematic view. The first bearing row 35 has first axial rolling bodies 45 and first radial rolling bodies 46 alternately in the ratio 1:2. The second bearing row 37 has second axial rolling bodies 47 and second radial rolling bodies 48 alternately in the ratio 1:2. Respective spacing means 49 are arranged between axially and radially arranged rolling bodies of the two bearing rows 35 and 37. A spacing means does not imperatively have to be present between the radially arranged rolling bodies 46, 48.

FIG. 6 shows only rolling bodies of a typical embodiment in a perspective, schematic view. What is shown is a first bearing row 35 with first axial rolling bodies 45 and first radial rolling bodies 46, between which no respective spacing means are arranged.

The invention is not restricted to the embodiment described above; instead, the scope of the invention is determined by the appended claims.

### LIST OF REFERENCE SIGNS

1 Gear mechanism
3 (Inner) toothing
4 Ring gear
5 Tooth carrier
7 Guides
9 Teeth
11 Gear mechanism axis
13 Cam disk
14 Third housing part
24 First housing part/Bearing outer ring
34 Screws
35 First bearing row
37 Second bearing row
39 Axial bearing ring
45 First axial rolling body
46 First radial rolling body
47 Second axial rolling body
48 Second radial rolling body
49 Spacing means
55 First inner axial bearing running surface
56 First inner radial bearing running surface
57 Second inner radial bearing running surface
58 Second inner axial bearing running surface
65 First outer axial bearing running surface
66 First outer radial bearing running surface
67 Second outer radial bearing running surface
68 Second outer axial bearing running surface

1. Gear mechanism (1), comprising
a housing with a fixedly arranged toothing (3),
a tooth carrier (5) which is rotatable about a gear mechanism axis (11) relative to the housing and has guides (7),
teeth (9), which are received in the guides (7) for engagement with the toothing (3), wherein the teeth (9) are mounted in the guides (7) so as to be displaceable in the direction of their longitudinal axis relative to the tooth carrier (5),
a cam disk (13) which is rotatable about the gear mechanism axis (11) and is intended to drive the teeth (9) along the respective longitudinal axis of the teeth (9), and
a bearing row (35, 37) between the tooth carrier (5) and the housing for mounting the tooth carrier (5) in the housing, wherein the bearing row (35, 37) comprises axial rolling bodies (45, 47), the axes of rotation of which are aligned perpendicularly in relation to the gear mechanism axis (11), and radial rolling bodies (46, 48), the axes of rotation of which are aligned parallel to the gear mechanism axis (11).

2. Gear mechanism (1) according to claim 1, wherein the gear mechanism is a coaxial gear mechanism.

3. Gear mechanism (1) according to claim 1, wherein the housing has a multi-part form and comprises a first housing part (24) in the form of a bearing outer ring, and wherein a ring gear (4) with the inner toothing (3) forms a second housing part of the housing.

4. Gear mechanism (1) according to claim 1, wherein the tooth carrier (5) has a one-part form.

5. Gear mechanism (1) according to claim 1, wherein the tooth carrier (5) has at least one radial bearing running surface and at least one axial bearing running surface.

6. Gear mechanism (1) according to claim 5, wherein the tooth carrier (5) has at least two bearing running surfaces.

7. Gear mechanism (1) according to claim 1, wherein the bearing row is a first bearing row (35) of a bearing of the tooth carrier, and wherein the bearing comprises a second bearing row (37) which has at least axial rolling bodies.

8. Gear mechanism (1) according to claim 7, wherein the two bearing rows (35, 37) are arranged next to one another and/or next to the tooth guide on one side in the direction of the gear mechanism axis.

9. Gear mechanism (1) according to claim 7, wherein the radial rolling bodies and/or the axial rolling bodies respectively of the first bearing row and/or the second bearing row each have a cylindrical shape with a diameter which is larger than a length of the cylindrical shape.

10. Gear mechanism (1) according to claim 7, wherein the first bearing row and the second bearing row each have axial rolling bodies and radial rolling bodies.

11. Gear mechanism (1) according to claim 7, wherein the second bearing row has exclusively axial rolling bodies.

12. Gear mechanism (1) according to claim 3, wherein the bearing outer ring has at least one axial and at least one radial bearing running surface.

13. Gear mechanism according to claim 12, comprising an axial bearing ring which has an axial bearing running surface.

14. Gear mechanism according to claim 1, wherein the cam disk is in the form of a hollow shaft.

15. Gear mechanism according to claim 1, wherein spacing means (49, 50) are inserted between the rolling bodies.

16. Use of a gear mechanism (1) according to claim 1.
